(19) United States
(12) Patent Application Publication
(10) Pub. No.: US 2012/0094691 A1
(43) Pub. Date: Apr. 19, 2012

(54) Method and Device for Transmitting Positioning Information

(75) Inventors: Shi Chen, Shenzhen (CN); Yuanjie Li, Shanghai (CN)

(73) Assignee: HUAWEI TECHNOLOGIES CO., LTD., Shenzhen (CN)

(21) Appl. No.: 13/331,987

(22) Filed: Dec. 20, 2011

Related U.S. Application Data
(63) Continuation of application No. PCT/CN2010/074172, filed on Jun. 21, 2010.

(30) Foreign Application Priority Data
Jun. 22, 2009 (CN) 200910150704.6

(51) Int. Cl. H04W 4/02

(52) U.S. Cl. 455/456.1

(57) ABSTRACT

A method and a device for transmitting positioning information are provided in the embodiments of the present invention. The method includes: determining a positioning sub-frame for transmitting a positioning reference signal (PRS); and transmitting the PRS according to the positioning sub-frame. Through the embodiments of the present invention, the transmission of a PRS according to a positioning sub-frame ensures the normal transmission of a synchronization channel (SCH) and/or a broadcast channel (BCH), and the transmission of the positioning sub-frame has no effect on the detection performance of the SCH and/or the BCH.

### CROSS-REFERENCE TO RELATED APPLICATIONS

This application is a continuation of International Application No. PCT/CN2010/074172, filed on Jun. 21, 2010, which claims priority to Chinese Patent Application No. 200910150704.6, filed with the Chinese Patent Office on Jun. 22, 2009 and entitled “METHOD AND DEVICE FOR TRANSMITTING POSITIONING INFORMATION”, both of which are incorporated herein by reference in their entireties.

### FIELD OF THE INVENTION

The present invention relates to the field of communications technology, and in particular, to a method and a device for transmitting positioning information.

### BACKGROUND OF THE INVENTION

In a long term evolution (LTE) system, LTE Release 9 (R9) uses a positioning technology based on observed time difference of arrival (OTDOA) to determine the position of a user equipment (UE). The basic principle of the positioning technology is as follows: when three or more base stations exist in the system, the position of the UE may be determined according to a time difference of arrival of downlink transmission signals of different base stations; and the more base stations the system has, the more accurate the determined position of the UE is.

Therefore, in the LTE system, one of the main factors which affect positioning accuracy is the monitoring capability of the UE. The more cells the UE is capable of monitoring, the higher the positioning accuracy is. In order to improve the monitoring capability of the UE, a special positioning sub-frame is employed to measure a time difference of arrival of different base stations. Moreover, in order to improve the positioning accuracy, the positioning sub-frame may be accumulated continuously in time. For example, the number of continuously accumulated sub-frames may be 1, 2, 4, 6, or the like. The positioning sub-frame is a sub-frame which is adapted to transmit a positioning signal and enable a terminal to perform positioning according to the transmitted positioning signal, and is also called an enhanced-idle periodical downline (E-IPDL) sub-frame or a low interference sub-frame (LIS).

In the prior art, because the continuous accumulation of positioning sub-frames in time is supported in the LTE system, the positioning sub-frame may conflict with sub-frames for other uses, for example, a positioning sub-frame may conflict with a sub-frame including a synchronization channel (SCH) and/or a broadcast channel (BCH), which therefore affects system performance.

### SUMMARY OF THE INVENTION

The present invention is directed to a method and a device for transmitting positioning information. In the method, transmitting positioning reference information is transmitted according to a positioning sub-frame, so as to ensure that no conflict occurs between the positioning sub-frame and sub-frames for other uses, which therefore has no detrimental effect on the system performance.

An embodiment of the present invention provides a method for transmitting positioning information, where the method includes: determining a positioning sub-frame for transmitting a positioning reference signal (PRS); and transmitting the PRS according to the positioning sub-frame.

An embodiment of the present invention further provides a device for transmitting positioning information, where the device includes: a determining unit, adapted to determine a positioning sub-frame for transmitting a PRS; and a transmitting unit, adapted to transmit the PRS according to the positioning sub-frame.

Through the method and the device of the present invention, the transmission of positioning reference information according to a positioning sub-frame ensures that no conflict occurs between the positioning sub-frame and sub-frames for other uses, which therefore has no effect on the system performance.

### DETAILED DESCRIPTION OF THE DRAWINGS

To illustrate the technical solution according to the embodiments of the present invention or in the prior art more clearly, the accompanying drawings for describing the embodiments are introduced briefly in the following. Apparently, the accompanying drawings in the following description are some embodiments of the present invention, and persons skilled in the art may derive other drawings from the accompanying drawings without creative efforts.

FIG. 1 is a flow chart of a method for transmitting positioning information according to Embodiment 1 of the present invention;

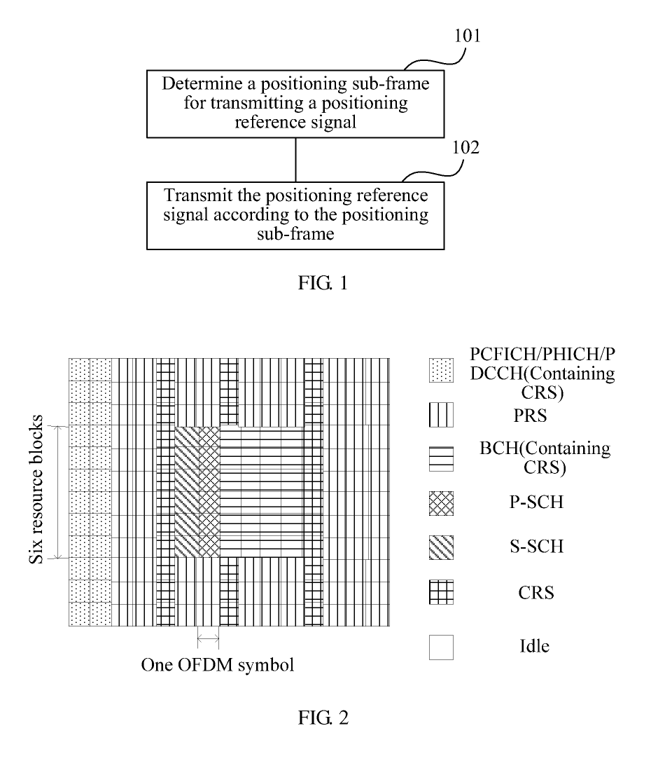

FIG. 2 is a first schematic diagram of transmitting a PRS according to Embodiment 2 of the present invention;

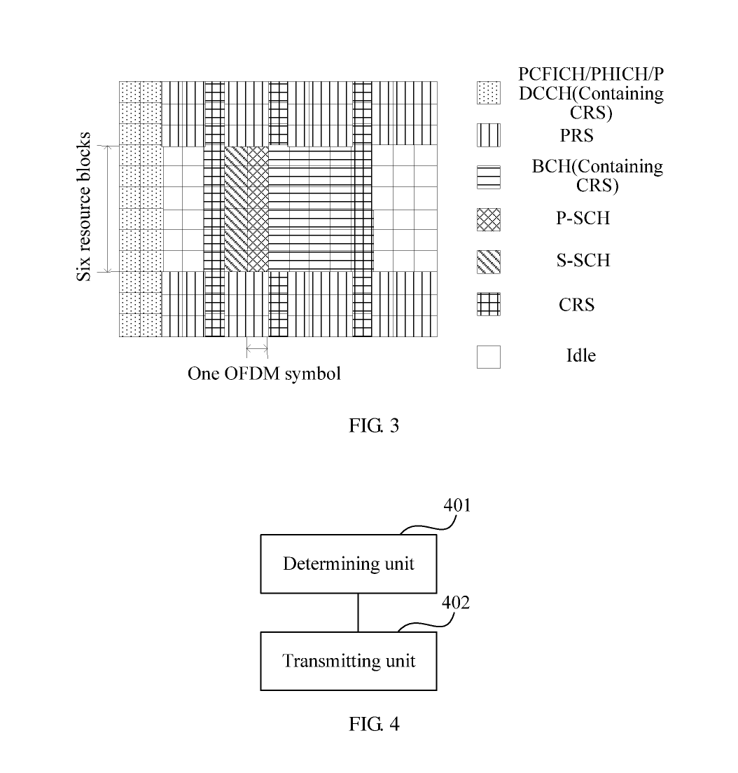

FIG. 3 is a second schematic diagram of transmitting a PRS according to Embodiment 2 of the present invention; and

FIG. 4 is a schematic constitutional diagram of a device for transmitting positioning information according to Embodiment 6 of the present invention.

### DETAILED DESCRIPTION OF THE EMBODIMENTS

The technical solution of the present invention is clearly and completely described in the following with reference to the accompanying drawings. It is obvious that the embodiments to be described are a part rather than all of the embodiments of the present invention. All other embodiments obtained by persons skilled in the art based on the embodiments of the present invention without creative efforts shall fall within the protection scope of the present invention.

### Embodiment 1

As shown in FIG. 1, this embodiment provides a method for transmitting positioning information, in which the method includes:

Step 101: Determine a positioning sub-frame for transmitting a PRS; and

Step 102: Transmit the PRS according to the positioning sub-frame.

In this embodiment, the positioning sub-frame may be a normal sub-frame, a multicast broadcast single frequency network (MBSFN) sub-frame, or a persistently scheduled physical downlink shared channel (PDSCH) sub-frame, but it is not limited to the above sub-frames and may be determined according to an actual situation. The normal sub-frame may be a common data transmission sub-frame.

In an LTE system, because the positioning sub-frame is accumulated continuously in time, for example, the number of continuously accumulated sub-frames may be 1, 2, 4, or 6, the transmission of a PRS may be decided according to the positioning sub-frame. In this way, it is ensured that no conflict occurs between the positioning sub-frame and sub-frames for other uses, which therefore has no effect on the system performance.

In other embodiments, when the positioning sub-frame is a normal sub-frame, and the positioning sub-frame is a sub-frame including an SCH and/or a BCH, the transmitting the PRS according to the positioning sub-frame may include: not transmitting the PRS on an orthogonal frequency division multiplexing (OFDM) symbol that transmits the SCH and/or the BCH; or not transmitting the PRS on a resource block that transmits the SCH and/or the BCH; or not transmitting the PRS on a resource element that transmits the SCH and/or the BCH.

In other embodiments, when the positioning sub-frame is a normal sub-frame, and the positioning sub-frame is a sub-frame including an SCH and/or a BCH, the transmitting the PRS according to the positioning sub-frame may include: transmitting the PRS on an OFDM symbol that does not transmit the SCH and/or the BCH, and on an OFDM symbol that does not transmit a cell-specific reference signal (CRS), a physical control format indicator channel (PCFICH), a physical hybrid automatic repeat request (ARQ) indicator channel (PHICH), and a physical downlink control channel (PDCCH).

In other embodiments, when the positioning sub-frame is a normal sub-frame, and the positioning sub-frame is a sub-frame including an SCH and/or a BCH, the transmitting the PRS according to the positioning sub-frame may include: transmitting the PRS on a resource element that does not transmit the SCH and/or the BCH, and on an OFDM symbol that does not transmit a CRS, a PCFICH, a PHICH, and a PDCCH.

In other embodiments, when the positioning sub-frame is a normal sub-frame, and the positioning sub-frame is a sub-frame including an SCH and/or a BCH, the transmitting the PRS according to the positioning sub-frame may include: transmitting the PRS on an OFDM symbol that does not transmit a CRS, a PCFICH, a PHICH, and a PDCCH, wherein the OFDM symbol is in other resource blocks than a resource block that transmits the SCH and/or the BCH.

### Embodiment 2

This embodiment provides a method for transmitting positioning information, in which the method is described in detail in the following with reference to FIG. 2 and FIG. 3 by taking a situation that the positioning sub-frame is a normal sub-frame as an example.

In this embodiment, when it is determined that the positioning sub-frame is a sub-frame including an SCH and/or a BCH, the following manner may be adopted: the PRS is not transmitted on the sub-frame including the SCH and/or the BCH. In this way, the operation is simple, and no effect is produced on detection performance of the SCH and/or the BCH.

In this embodiment, when the PRS is not transmitted on the sub-frame including the SCH and/or the BCH, the PRS may be transmitted by using a next non-conflict sub-frame (such as a sub-frame not including an SCH and/or a BCH). In this way, no PRS is lost, and no effect is produced on the positioning accuracy, which has more obvious advantages especially when system bandwidth is small. Because when the bandwidth is small, signals for positioning in each sub-frame are few, at this time, accumulation in time is necessary, and transmitting the positioning signal by using the next non-conflict sub-frame may ensure the accumulation of the positioning signal in time.

In this embodiment, when it is determined that the positioning sub-frame for transmitting the PRS is a sub-frame including an SCH and/or a BCH, the following manner may also be adopted: the PRS is not transmitted at a position where a conflict occurs. For example, the PRS is not transmitted on an OFDM symbol that transmits the SCH and/or the BCH, or on a resource block that transmits the SCH and/or the BCH, or on a resource element that transmits the SCH and/or the BCH.

FIG. 2 and FIG. 3 show two solutions for transmitting a PRS provided in this embodiment. The SCH and the BCH locate in the middle six resource blocks. The positioning sub-frame not only transmits the PRS, but also transmits a CRS, a PCFICH, a PHICH, and a PDCCH. It may be understood by persons skilled in the art that the embodiment of the present invention is not limited to the solutions shown in FIG. 2 and FIG. 3, and other solutions may also be adopted. For example, in some situations, the positioning sub-frame may also contain other control channels, or may not contain one or more of the CRS, the PCFICH, the PHICH, and the PDCCH. The embodiment of the present invention is described in detail in the following with reference to FIG. 2 and FIG. 3.

As shown in FIG. 2, a PRS may not be transmitted on a resource element that transmits the SCH and the BCH (that is, the PRS is not transmitted on a resource element including the SCH and the BCH in the middle six resource blocks), and the PRS may not be transmitted on an OFDM symbol including a CRS, a PCFICH, a PHICH, and a PDCCH. In this way, the PRS is transmitted on other resource elements than the resource element that transmits the SCH and the BCH in the middle six resource blocks, and on other OFDM symbols than the OFDM symbol that transmits the CRS, the PCFICH, the PHICH, and the PDCCH, which therefore reduces the number of lost PRSs due to a sub-frame conflict, and also reduces the effect on the positioning accuracy.

As shown in FIG. 3, a PRS may not be transmitted in a resource block that transmits the SCH and the BCH (that is, the PRS is not transmitted in the middle six resource blocks), and the PRS may not be transmitted on an OFDM symbol including a CRS, a PCFICH, a PHICH, and a PDCCH in other resource blocks. In this way, the PRS is transmitted on an OFDM symbol that does not transmit the CRS, the PCFICH, the PHICH, and the PDCCH, wherein the OFDM symbol is in other resource blocks than a resource block that transmits the SCH and/or the BCH.

In an LTE system, because transmit power of the PRS is high, when a user in an adjacent cell detects the SCH and/or the BCH of the cell, interference of the PRS from other cells easily occurs. Through a frame structure shown in FIG. 3 according to the embodiment of the present invention, because the PRS is not transmitted in the middle six resource blocks, the PRS has no effect on the detection performance of the SCH and/or the BCH. In addition, because the PRS is not transmitted in only the middle six resource blocks, when the system bandwidth is large, the effect of the sub-frame conflict on the positioning accuracy is limited.

In this embodiment, when the positioning sub-frame is a normal sub-frame, and when it is determined that the positioning sub-frame for transmitting the PRS is a sub-frame including the SCH and/or the BCH, if the PRS occupies a part of the bandwidth, the PRS may be transmitted, by scheduling manner, on resource block that does not transmit the SCH and/or the BCH. For example, the PRS may be transmitted on an OFDM symbol that does not transmit a CRS, a PCFICH, a PHICH, and a PDCCH in a resource block except the middle six resource blocks. When the solution is adopted, because the PRS occupies a part of the bandwidth, a base station may be required to inform an UE, by scheduling manner, of the resource block (or a band) that transmits the PRS. When the PRS occupies a part of the bandwidth, continuous PRSs may be transmitted by scheduling manner, which therefore ensures the positioning accuracy of the UE.

It may be known from the embodiment that, when the positioning sub-frame is a normal sub-frame, and the positioning sub-frame is a sub-frame including an SCH and/or a BCH, a PRS is transmitted on an OFDM symbol that does not transmit the SCH and/or the BCH, or the PRS is transmitted on a resource block that does not transmit the SCH and/or the BCH, or the PRS is transmitted on a resource element that does not transmit the SCH and/or the BCH, or the PRS is not transmitted on the sub-frame including the SCH and/or the BCH. Thereby, the conflict between the positioning sub-frame and the sub-frame including the SCH and/or the BCH may be prevented as much as possible, so that the effect of the conflict on the detection performance of the SCH and/or the BCH and the positioning accuracy and the limitation of the conflict on the base station scheduling are reduced.

### Embodiment 3

This embodiment provides a method for transmitting positioning information, in which the method is described in detail in the following by taking a situation that the positioning sub-frame is an MBSFN sub-frame as an example.

It may be known by persons skilled in the art that, in a frequency division duplex (FDD) mode, only a sub-frame 1, a sub-frame 2, a sub-frame 3, a sub-frame 6, a sub-frame 7, and a sub-frame 8 may be used as MBSFN sub-frames; and in a time division duplex (TDD) mode, only a sub-frame 3, a sub-frame 4, a sub-frame 7, a sub-frame 8, and a sub-frame 9 may be used as MBSFN sub-frames. Therefore, if the MBSFN sub-frame is selected as the positioning sub-frame, because the positioning sub-frame requires continuous accumulation in time, the positioning sub-frame may conflict with sub-frames for other uses (or called non-MBSFN sub-frames). For example, when the number of continuously accumulated positioning sub-frames is four, which is required in the FDD mode, because only three continuous MBSFN sub-frames are adopted to transmit a PRS, to meet the condition that the number of the continuously accumulated positioning sub-frames is four, a conflict occurs between the positioning sub-frame and the sub-frames for other uses.

Therefore, in this embodiment, a PRS may be transmitted only on continuous MBSFN sub-frames even if the number of the continuous MBSFN sub-frames is smaller than the required number of the continuously accumulated positioning sub-frames. For example, if the required number of the continuously accumulated positioning sub-frames is four, a PRS may be transmitted on the sub-frame 1, the sub-frame 2, and the sub-frame 3 in the FDD mode. Although this solution may not be able to achieve the number of the continuously accumulated sub-frames, the operation is simple, and the conflict between the PRS and the sub-frames for other uses is avoided.

In this embodiment, a PRS may also be transmitted on non-continuous MBSFN sub-frames whose number is equal to the number of the continuously accumulated positioning sub-frames. For example, if the required number of the continuously accumulated positioning sub-frames is four, the PRS may be transmitted on the sub-frame 1, the sub-frame 2, the sub-frame 3, and the sub-frame 6 in the FDD mode; and the PRS may be transmitted on the sub-frame 3, the sub-frame 4, the sub-frame 7, and the sub-frame 8 in the TDD mode. In this way, no PRS is lost due to the sub-frame conflict, which therefore has no effect on the positioning accuracy.

Of course, in this embodiment, when the number of the continuous MBSFN sub-frames is smaller than the number of the continuously accumulated positioning sub-frames, a PRS may be transmitted by partially using the MBSFN sub-frames and partially using normal sub-frames. That is, the number of the continuous MBSFN sub-frames and the non-MBSFN sub-frames which transmit the PRS is equal to the number of the continuously accumulated positioning sub-frames.

### Embodiment 4

This embodiment provides a method for transmitting positioning information.

When a TDD mode is adopted, only a sub-frame 3, a sub-frame 4, a sub-frame 7, a sub-frame 8, and a sub-frame 9 may be used as positioning sub-frames. In addition, it should be noted that, as for the TDD, the proportion of special sub-frames and uplink sub-frames in some uplink/downlink distribution ratios is large, for example, an uplink/downlink distribution ratio is zero, as shown in Table 1:

TABLE 1

| Uplink/ | | | | | | | | | | |
|---|---|---|---|---|---|---|---|---|---|---|
| downlink | | | | | | | | | | |
| distribution | Sub-frame number | | | | | | | | | |
| ratio | 0 | 1 | 2 | 3 | 4 | 5 | 6 | 7 | 8 | 9 |
| 0 | D | S | U | U | U | D | S | U | U | U |

It may be known from Table 1 that, only the sub-frame 0 and the sub-frame 5 may be used as downlink sub-frames. Because the sub-frame 0 and the sub-frame 5 contain an SCH and/or a BCH, no sub-frame may be used as a positioning sub-frame in the case that the uplink/downlink distribution ratio is zero. In this way, when a conflict occurs between the positioning sub-frame and the sub-frames for other uses, it is preferred that the positioning sub-frame performs no transmission.

### Embodiment 5

This embodiment provides a method for transmitting positioning information.

In this embodiment, when a positioning sub-frame is a sub-frame including a persistent scheduled PDSCH, the persistent scheduled PDSCH may be abandoned, and a PRS is transmitted.

Because the sub-frame of the persistent scheduled PDSCH is configured by high-layer signaling, and a positioning period is much longer than a persistent scheduling period, when the positioning sub-frame conflicts with the sub-frame of the persistent scheduled PDSCH, the effect of abandoning the persistent scheduled PDSCH is small. At the same time, because the persistent scheduling has a hybrid automatic retransmission request (HARD) process, when initial transmission makes a mistake, retransmission may make up the performance of the persistent scheduled PDSCH.

It may be known from the embodiment that, no detrimental effect is produced on the system performance while the positioning accuracy is ensured through the aforementioned method.

### Embodiment 6

This embodiment provides a device for transmitting positioning information. As shown in FIG. 4, the device includes a determining unit 401 and a transmitting unit 402. The determining unit 401 is adapted to determine a positioning sub-frame for transmitting a PRS; and the transmitting unit 402 is connected to the determining unit 401, and is adapted to transmit the PRS according to the positioning sub-frame.

It may be known from the embodiment that, the transmission of the PRS is decided according to the positioning sub-frame. In this way, it is ensured that no conflict occurs between the positioning sub-frame and the sub-frames for other uses, which therefore has no effect on the system performance.

### Embodiment 7

This embodiment provides a device for transmitting positioning information.

In this embodiment, when the determining unit 401 determines that a positioning sub-frame is a normal sub-frame, and the positioning sub-frame is a sub-frame including an SCH and/or a BCH, the transmitting unit 402 does not transmit a PRS on the sub-frame including the SCH and/or the BCH. In this way, the operation is simple, and no effect is produced on the detection performance of the SCH and/or the BCH.

In this embodiment, when the determining unit 401 determines that the positioning sub-frame is a normal sub-frame, and the transmitting unit 402 does not transmit a PRS on the sub-frame including the SCH and/or the BCH, the transmitting unit 402 may also use a next non-conflict sub-frame (for example, a sub-frame not including an SCH and/or a BCH) to transmit the PRS. In this way, no PRS is lost, and no effect is produced on the positioning accuracy, which has more obvious advantages especially when the system bandwidth is small.

In this embodiment, when the determining unit 401 determines that the positioning sub-frame is a normal sub-frame, and the positioning sub-frame is a sub-frame including an SCH and/or a BCH, the transmitting unit 402 does not transmit a PRS at a position where a conflict occurs. For example, the PRS is not transmitted on an OFDM symbol that transmit the SCH and/or the BCH, or on a resource block that transmit the SCH and/or the BCH, or on a resource element that transmit the SCH and/or the BCH, which is as described in Embodiment 2 and is not described herein again.

In this embodiment, when the determining unit 401 determines that the positioning sub-frame is a normal sub-frame, the positioning sub-frame is a sub-frame including an SCH and/or a BCH, and the PRS occupies a part of the bandwidth, the transmitting unit 402 may transmit the PRS on a resource block not including the SCH and/or the BCH by scheduling manner. The specific transmission manner is as described in Embodiment 2, and is not described herein again. When the solution is adopted, because the PRS occupies only a part of the bandwidth, a base station may be required to inform an UE, by scheduling manner, of the resource block (or the band) transmitting the PRS. When the PRS occupies a part of the bandwidth, continuous PRSs may be transmitted by scheduling manner, which may ensure the positioning accuracy of the UE.

In this embodiment, when the determining unit 401 determines that the positioning sub-frame is an MBSFN sub-frame, and the number of continuous MBSFN sub-frames is smaller than the number of continuously accumulated positioning sub-frames, the transmitting unit 402 transmits the PRS only on the continuous MBSFN sub-frames. The transmission manner is as described in Embodiment 3, and is not described herein again.

In this embodiment, when the determining unit determines that the positioning sub-frame is an MBSFN sub-frame, and the number of continuous MBSFN sub-frames is smaller than the number of continuously accumulated positioning sub-frames, the transmitting unit 402 may also transmit the PRS on non-continuous MBSFN sub-frames whose number is equal to the number of the continuously accumulated positioning sub-frames.

In this embodiment, when the determining unit 401 determines that the positioning sub-frame is an MBSFN sub-frame, and the number of continuous MBSFN sub-frames is smaller than the number of continuously accumulated positioning sub-frames, the transmitting unit 402 may also transmit the PRS by partially using the MBSFN sub-frames and partially using normal sub-frames. That is, the number of the continuous MBSFN sub-frames and the non-MBSFN sub-frames which transmit the PRS is equal to the number of the continuously accumulated positioning sub-frames.

In this embodiment, when a TDD mode is adopted, and the determining unit 401 determines that the positioning sub-frame conflicts with sub-frames for other uses, the transmitting unit 402 does not transmit the PRS, which is as described in Embodiment 4, and is not described herein again.

In this embodiment, when the determining unit 401 determines that the positioning sub-frame is a sub-frame including a persistent scheduled PDSCH, the transmitting unit 402 may abandon the persistent scheduled PDSCH and transmit the PRS. In this way, because the sub-frame of the persistent scheduled PDSCH is configured by high-layer signaling, and a positioning period is much longer than a persistent scheduling period, when the positioning sub-frame conflicts with the persistent scheduled PDSCH, the effect of abandoning the persistent scheduled PDSCH is small. At the same time, because the persistent scheduling has an HARQ process, when the initial transmission makes a mistake, retransmission may make up the performance of the persistent scheduled PDSCH.

It may be known from the embodiment that, no detrimental effect is produced on the system performance while the positioning accuracy is ensured through the above device.

It may be further known by persons skilled in the art that, the units and the algorithm steps of each example that are described with reference to the embodiments disclosed herein may be implemented by electronic hardware, computer software, or a combination of electronic hardware and computer software. In order to clearly describe the interchangeability of the hardware and the software, the constitution and the steps of each example have been generally described according to the functions in the foregoing description. The situation that these functions are performed by hardware or software depends on specific application and a design constraint of the technical solutions. Persons skilled in the art may implement the described functions by using different methods for each specific application, and such implementation should not be regarded as going beyond the scope of the present invention.

The steps of the methods or algorithms described with reference to the embodiments disclosed herein may be implemented by hardware, a software module executed by a processor, or a combination of hardware and a software module executed by a processor. The software module may be disposed in a Random Access Memory (RAM), a memory, a Read-Only Memory (ROM), an electrically programmable ROM, an electrically erasable and programmable ROM, a register, a hard disk, a removable magnetic disk, a Compact Disk Read-Only Memory (CD-ROM), or any other storage medium well known in the art.

The objectives, technical solutions, and beneficial effects of the present invention have been described in further detail through the above specific embodiments. It should be noted that, the above descriptions are specific embodiments of the present invention, but are not intended to limit the protection scope of the present invention. Any modification, equivalent replacement, or improvement made without departing from the spirit and principle of the present invention should fall within the protection scope of the present invention.

1. A method for transmitting positioning information, the method comprising:
determining a positioning sub-frame for transmitting a positioning reference signal (PRS); and
transmitting the PRS according to the positioning sub-frame; wherein
when the positioning sub-frame is a normal sub-frame, and the positioning sub-frame is a sub-frame comprising a synchronization channel (SCH) and/or a broadcast channel (BCH), the transmitting the PRS according to the positioning sub-frame comprises:
not transmitting the PRS on an orthogonal frequency division multiplexing (OFDM) symbol, on a resource block, or on a resource element that transmits the SCH and/or the BCH.

2. The method according to claim 1, wherein the transmitting the PRS according to the positioning sub-frame further comprises:
transmitting the PRS on an OFDM symbol that does not transmit the SCH and/or the BCH; or transmitting the PRS on a resource block that does not transmit the SCH and/or the BCH; or transmitting the PRS on a resource element that does not transmit the SCH and/or the BCH.

3. The method according to claim 1, wherein the transmitting the PRS according to the positioning sub-frame further comprises:
transmitting the PRS on an OFDM symbol that does not transmit a cell-specific reference signal (CRS), a physical control format indicator channel (PCFICH), a physical hybrid automatic repeat request (ARQ) indicator channel (PHICH), and a physical downlink control channel (PDCCH).

4. The method according to claim 1, wherein when the positioning sub-frame is a normal sub-frame, the positioning sub-frame is a sub-frame comprising the SCH and/or the BCH, and the PRS occupies a part of bandwidth,
the transmitting the PRS according to the positioning sub-frame further comprises:
transmitting, by scheduling manner, the PRS on an OFDM symbol that does not transmit a CRS, a PCFICH, a PHICH, and a PDCCH, wherein the OFDM symbol is in other resource blocks than a resource block that does not transmit the SCH and/or the BCH.

5. A device for transmitting positioning information, the device comprising:
a determining unit, configured to determine a positioning sub-frame for transmitting a positioning reference signal (PRS); and
a transmitting unit, configured to transmit the PRS according to the positioning sub-frame; wherein
when the positioning sub-frame determined by the determining unit is a normal sub-frame, and the positioning sub-frame is a sub-frame comprising a synchronization channel (SCH) and/or a broadcast channel (BCH),
the transmitting unit is further configured to not transmit the PRS on an orthogonal frequency division multiplexing (OFDM) symbol that transmits the SCH and/or the BCH; or not transmit the PRS on a resource block that transmits the SCH and/or the BCH; or not transmit the PRS on a resource element that transmits the SCH and/or the BCH.

6. The device according to claim 5, wherein
the transmitting unit is further configured to transmit the PRS on an OFDM symbol that does not transmit the SCH and/or the BCH; or transmit the PRS on a resource block that does not transmit the SCH and/or the BCH; or transmit the PRS on a resource element that does not transmit the SCH and/or the BCH.

7. The device according to claim 5, wherein
the transmitting unit is further configured to transmit the PRS on an OFDM symbol that does not transmit a cell-specific reference signal (CRS), a physical control format indicator channel (PCFICH), a physical hybrid automatic repeat request (ARQ) indicator channel (PHICH), and a physical downlink control channel (PDCCH).

8. The device according to claim 5, wherein when the positioning sub-frame determined by the determining unit is a normal sub-frame, the positioning sub-frame is a sub-frame comprising the SCH and/or the BCH, and the PRS occupies a part of bandwidth,
the transmitting unit is further configured to transmit, by scheduling manner, the PRS on an OFDM symbol that does not transmit a CRS, a PCFICH, a PHICH, and a PDCCH, wherein the OFDM symbol is in other resource blocks than a resource block that does not transmit the SCH and/or the BCH.

9. A computer readable medium, comprising:
a computer program code, which, when executed by a computer unit, will cause the computer unit to perform a first step of determining a positioning sub-frame for transmitting a positioning reference signal (PRS); and
a second step of transmitting the PRS according to the positioning sub-frame; wherein
when the positioning sub-frame is a normal sub-frame, and the positioning sub-frame is a sub-frame comprising a synchronization channel (SCH) and/or a broadcast channel (BCH), the second step of transmitting the PRS according to the positioning sub-frame comprises:
not transmitting the PRS on an orthogonal frequency division multiplexing (OFDM) symbol, on a resource block, or on a resource element that transmits the SCH and/or the BCH.

10. The method according to claim 9, wherein the second step of transmitting the PRS according to the positioning sub-frame further comprises:
transmitting the PRS on an OFDM symbol that does not transmit the SCH and/or the BCH; or transmitting the PRS on a resource block that does not transmit the SCH and/or the BCH; or transmitting the PRS on a resource element that does not transmit the SCH and/or the BCH.

11. The method according to claim 9, wherein the second step of transmitting the PRS according to the positioning sub-frame further comprises:
transmitting the PRS on an OFDM symbol that does not transmit a cell-specific reference signal (CRS), a physical control format indicator channel (PCFICH), a physical hybrid automatic repeat request (ARQ) indicator channel (PHICH), and a physical downlink control channel (PDCCH).

12. The method according to claim 9, wherein when the positioning sub-frame is a normal sub-frame, the positioning sub-frame is a sub-frame comprising the SCH and/or the BCH, and the PRS occupies a part of bandwidth,
the second step of transmitting the PRS according to the positioning sub-frame further comprises:
transmitting, by scheduling manner, the PRS on an OFDM symbol that does not transmit a CRS, a PCFICH, a PHICH, and a PDCCH, wherein the OFDM symbol is in other resource blocks than a resource block that does not transmit the SCH and/or the BCH.
